(19) United States
(12) Patent Application Publication
(10) Pub. No.: US 2015/0350473 A1
(43) Pub. Date: Dec. 3, 2015

(54) IMAGE FORMING APPARATUS THAT EXECUTES APPLICATION, IMAGE FORMATION METHOD, AND RECORDING MEDIUM

(71) Applicant: KYOCERA DOCUMENT SOLUTIONS INC., Osaka (JP)

(72) Inventors: Masato HIROTA, Osaka (JP); Tomihito DOI, Osaka (JP); Koji IKAWA, Osaka (JP); Ayaka IKEJIMA, Osaka (JP); Satoshi IMAI, Osaka (JP); Daijiro KITAMOTO, Osaka (JP); Makoto KOWAKA, Osaka (JP); Kyota MITSUYAMA, Osaka (JP); Takashi MURAKAMI, Osaka (JP); Yosuke NAKAZATO, Osaka (JP); Tomonori NAOTA, Osaka (JP); Kentaro OKAMOTO, Osaka (JP); Minoru TAKAHASHI, Osaka (JP); Wataru TSUKUDA, Osaka (JP); Katsuji FURUSHIGE, Osaka (JP)

(73) Assignee: KYOCERA DOCUMENT SOLUTIONS INC., Osaka (JP)

(21) Appl. No.: 14/726,526

(22) Filed: May 30, 2015

(30) Foreign Application Priority Data
May 30, 2014 (JP) 2014-113092

(51) Int. Cl. H04N 1/00; H04N 1/04

(52) U.S. Cl. CPC H04N 1/00503; H04N 1/00671; H04N 1/04

(57) ABSTRACT

An image forming apparatus is provided with a control circuit. The apparatus control platform where the control circuit manages the hardware resources on an operating system. The standard-application executing part executes the standard application using the managed hardware resources. The extended application platform makes the function of the standard application executed use, and makes the hardware resources use, and it has a standard application service interface part that provides the common interface corresponding to the function of the standard application as an interface for using the function of the standard application. The standard function service searches presence or absence of the standard application, and when the standard application does not present, cancels use of the standard function service from the extended application.

### INCORPORATION BY REFERENCE

This application is based on and claims the benefit of priority from Japanese Patent Application No. 2014-113092 filed on May 30, 2014, the contents of which are hereby incorporated by reference.

### BACKGROUND

The present disclosure is related with an image forming apparatus, image formation method, and control program, and, especially, an image formation apparatus, an image formation method, and a control program that executes an application.

An image forming apparatus, such as an MFP (Multifunctional Peripheral, MFP) and a printer, can print a document and an image. Some of image forming apparatuses can install and execute an application (Application Software, and henceforth an “application.”)

These applications enable to add functions, such as PDF generation, card management, and running the books, to the image forming apparatus. Also, by an application, it is possible to cooperate with another apparatus, such as a camera.

As typical technology, an image forming apparatus has a common part of each application is taken out as application service and common system service, forms a platform by the application service, common system service, and a versatile OS, and equips a printer application, a copy application, and various applications on the platform.

### SUMMARY

An image forming apparatus according to an embodiment of the present disclosure is provided with a control circuit. The control circuit includes an apparatus control platform, a standard-application executing part, an extended application platform, and a standard application service interface part. The apparatus control platform manages hardware resources on an operating system. The standard-application executing part executes a standard application by using the hardware resources managed on the apparatus control platform. The extended application platform includes a standard function service for using function of the standard application executed by the standard-application executing part. The standard application service interface part provides a common interface corresponding to the function of the standard application as an interface for using the function of the standard application by the standard function service of the extended application platform.

An image formation method according to an embodiment of the present disclosure executed by an image forming apparatus having hardware resources comprises managing hardware resources on an operating system, executing a standard application by using managed hardware resources, using function of executed standard application, using the hardware resources, and providing a common interface corresponding to the function of the standard application as an interface for using the function of the standard application.

A computer readable non-transitory recording medium according to an embodiment of the present disclosure stores the control program executable by an image forming apparatus. The control program causes the image forming apparatus to manage the hardware resources on an operating system, execute the standard application by using managed hardware resources, use function of executed standard application, use the hardware resources, and provide a common interface corresponding to the function of the standard application as an interface for using the function of the standard application.

### BRIEF DESCRIPTION OF THE DRAWINGS

FIG. 1 illustrates the system configuration of the image forming apparatus related to the present embodiment;

FIG. 2 illustrates the control configuration of the image forming apparatus a shown in FIG. 1;

FIG. 3 illustrates the detailed configuration of the standard application service I/F part as shown in FIG. 2;

FIG. 4 illustrates the standard application function call process related to the present embodiment;

FIG. 5 illustrates the function selecting process and function use process as shown in FIG. 4; and

FIG. 6 illustrates the functional use cancelling process as shown in FIG. 4.

### DETAILED DESCRIPTION

### Embodiment

[The System Configuration of Image Forming Apparatus 1]

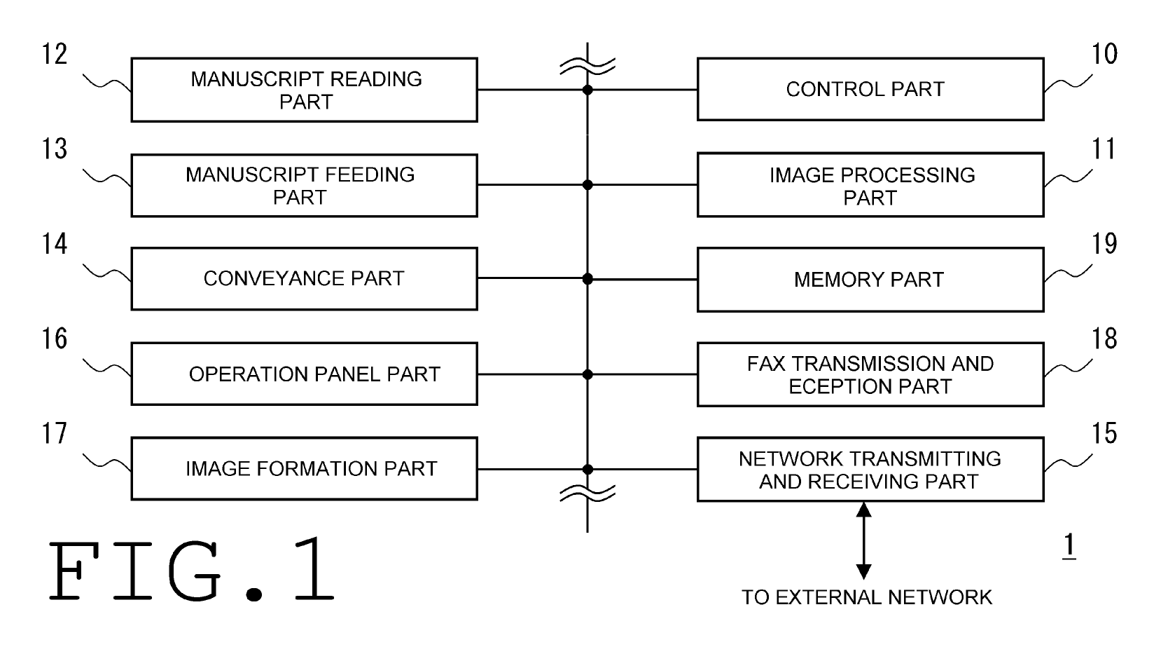

Then, referring to FIG. 1, the system configuration of image forming apparatus 1 is described. As for image forming apparatus 1, image processing part 11, manuscript reading part 12, manuscript feeding part 13, conveyance part 14, network transmitting and receiving part 15, operation panel part 16, image formation part 17, FAX transmission and reception part 18, and the memory part 19, or the like, are connected to control part 10. Each part is operation-controlled by control part 10.

Control part 10 is an information processing circuit. Control part 10 reads a control program memorized in memory part 19, executes by expanding this control program, and is operated as each part of a functional block as described later. Also, control part 10 controls a whole device according to instructing information input from an external terminal or operation panel part 16.

Image processing part 11 is a control operational circuit. Image processing part 11 executes specific image processing for various kinds of image data. Image processing part 11 performs, for example, the various image processing, such as scaling, density control, gradation adjustment, and an image improvement.

Image processing part 11 memorizes an image read by manuscript reading part 12 as print data in memory part 19. In this case, image processing part 11 can also convert the print data to a file having a format of PDF, TIFF, or the like.

Manuscript reading part 12 is a circuit that reads a set manuscript.

Manuscript feeding part 13 is a mechanism to convey the manuscript read by manuscript reading part 12.

Conveyance part 14 a mechanism that conveys a recording paper from a sheet paper cassette, makes perform image formation by image formation part 17, and conveys to a stack tray after that.

Image formation part 17 is a circuit that makes perform an image formation by an output instruction to the recording paper by a user for data memorized in memory part 19, read by manuscript reading part 12, or acquired from an external terminal.

Network transmitting and receiving part 15 is a network connection circuit including a LAN board, a wireless transmitter receiver, or the like, for connecting with external networks, such as LAN, wireless LAN, WAN, or a mobile phone network.

Network transmitting and receiving part 15 transmits and receives data in a data communication line and transmits and receives a sound signal in a voice telephone line.

Network transmitting and receiving part 15 may be connected to an external terminal, such as PC (Personal Computer), a smart phone, PDA (Personal Data Assistant), or a mobile phone, the server, or the like, via the network.

Operation panel parts 16 is a circuit that includes display parts, such as LCD, and an input part, such as a numeric keypad, a start, a cancel, buttons for switching operational modes, such as a copy (copy), FAX transmission, and a scanner, and buttons or a touch panel for performing instructions related to execute a job about print, transmission, memory, record, about the selected document or the like.

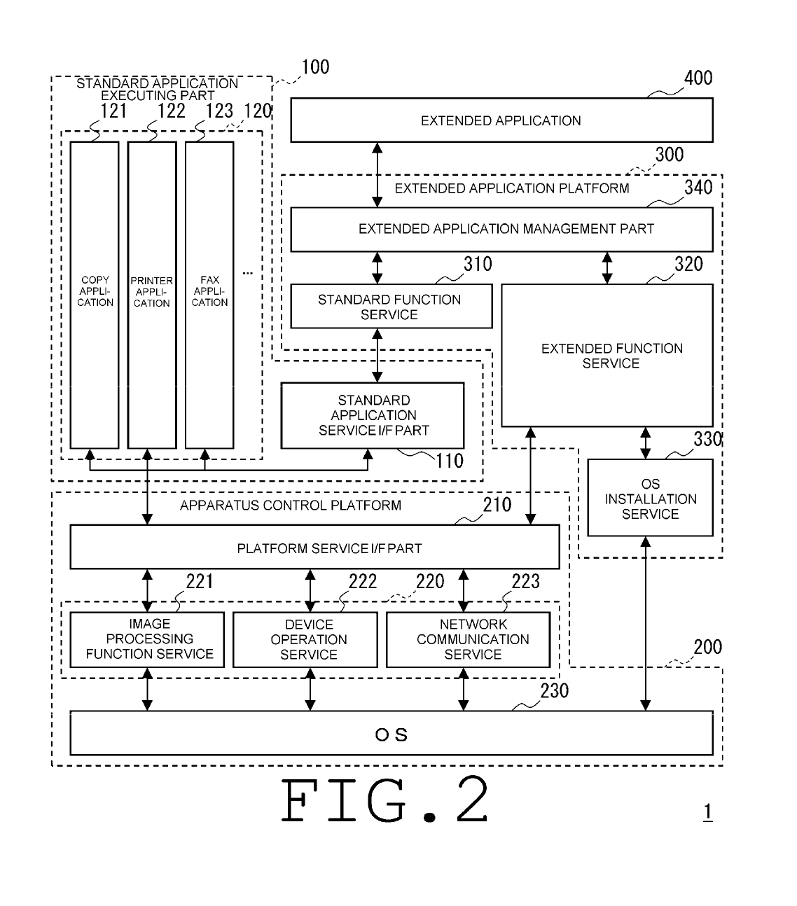

Operation panel part 16 is a circuit that acquires a user instruction. The user instruction includes an instruction for installation and use of extended application 400 (as shown in FIG. 2) (Application Software, application) which is described later. Also, by the user instruction, information of each user can be input and changed. Therefore, operation panel part 16 may have an exclusive control part and a recording media, such as ROM, and RAM, may cooperate with control part 10, and may control GUI (Graphical User Interface.) The details for controlling of operation panel part 16 at the time of installation or use of extended application 400 are described later.

Also, operation panel part 16 may be equipped with a connecting part for connecting an external apparatus having a recording medium or a recording medium itself, such as a USB memory or flash memory card.

FAX transmission and reception part 18 is a circuit, such as a FAX board that transmits and receives a facsimile.

FAX transmission and reception part 18 renders an image data read by manuscript reading part 12 or a file received by network transmitting and receiving part 15, or the like, and performs facsimile transmission. Also, FAX transmission and reception part 18, makes perform image formation of the image data memorized as a facsimile reception in memory part 19 by image formation part 17 or transmits to the external terminal from network transmitting and receiving part 15.

Memory part 19 is a circuit including a non-transitory recording medium and a controller, or the like.

In memory part 19, a control program and data for operation-controlling image forming apparatus 1 are memorized. The control program and data may be provided as a type of a firmware.

Also, the control program and data are expanded in run time and are executed by control part 10. Also, memory part 19 may be memorized various job data, image data scanned by manuscript reading part 12, image data being performed image processing by image processing part 11, a file such as a print document transmitted from another terminal, a various file read from connected recording medium, data of thumbnail images, or the like.

Also, memory part 19 may memorize an account setup of a user. Also, an area of a document box for each user may be included in memory part 19.

In addition, in image forming apparatus 1, control part 10 and image processing part 11 may be integrally formed as like CPU with built-in GPU, a chip-on module package, or the like.

Also, control part 10 and image processing part 11 may have built in RAM, ROM, a flash memory, or the like.

[The Control Configuration of Image Forming Apparatus 1]

Then, referring to FIG. 2, a control configuration of image forming apparatus 1 is described.

Image forming apparatus 1 is provided, as three hierarchical block structures, standard application executing part 100, apparatus control platform 200, extended application platform 300, and extended application 400. When control part 10 executes the control program of the present disclosure, standard application executing part 100, apparatus control platform 200, and extended application platform 300 are realized on the circuit of control part 10. Further, control part 10 can execute extended application 400, standard application 120, and OS 230 based on the control configuration as shown in FIG. 2. Specifically, a configuration that extended application 400 is executed on extended application platform 300 is shown.

Standard application executing part 100 is a circuit that executes standard application 120 by using hardware resources managed on apparatus control platform 200. Standard application executing part 100 includes standard application 120 installed on apparatus control platform 200 and a service corresponding to the standard application 120.

Apparatus control platform 200 is a circuit that manages hardware resources of entire image forming apparatus 1 as a whole on OS 230 (Operating System) and controls each part by a unit of the functional block.

Apparatus control platform. 200 is a program and data that includes, such as API (Application Programming Interface), middleware, run time, a linker, or the like, serving as the executing framework of standard application 120 (hereinafter, it is called “API, or the like”), service on OS 230 (Service, Daemon, and henceforth “service, or the like,”) interpreter (Interpreter), JIT (Just In Time Compiler), a virtual machine, or the like, for performing translation and execution of a program written in a script language or a intermediate language (hereinafter, it is called a “virtual machine, or the like.”) Also, extended application platform 300 itself is operated on OS 230.

Extended application platform 300 is a circuit that calls standard application 120 with using a function, calls apparatus control platform 200 with using the hardware resources, and manages and executes extended application 400.

Extended application platform 300 is a program and data including API, or the like, service, or the like, a virtual machine, or the like, which is an executing framework of extended application 400. Also, extended application platform 300 itself is also operated on OS 230.

Extended application 400 is a program and data of an application that performs various processing on extended application platform 300.

When it explains in more detail, standard application executing part 100 includes standard application 120 and standard application service I/F part 110 (standard application service interface part.)

Standard application 120 is a program and data of an application that performs various processing on apparatus control platform 200.

Standard application 120 acquires a user instruction and uses the various function of image forming apparatus 1 with the user instruction. Also, standard application 120, for example, may be an application of intermediate language, such as Java (registered trademark) or an application written in various script languages, or the like.

As standard application 120, for example, copy application 121, printer application 122, and the FAX application 123, or the like, may already be installed in a state of factory shipments.

Copy application 121 acquires instructions of a copy by a user from operation panel part 16, then makes read a manuscript in manuscript reading part 12, and makes perform image formation by image formation part 17.

Printer application 122 renders a file received by network transmitting and receiving part 15 by an instruction from an external terminal and written in PDL (Page Description Language) or the like, and makes perform image formation by image formation part 17. Also, printer application 122 may render a file in the document box of memory part 19, or the like, by an instruction of a user in operation panel part 16, and may make perform image formation performed by image formation part 17.

FAX application 123, when an instruction of the facsimile transmission from operation panel part 16 by a user is acquired, reads a manuscript by manuscript reading part 12, performs facsimile transmission by FAX transmission and reception part 18. Also, FAX application 123 may render a file, or the like, received from an external terminal and may transmit by FAX transmission and reception part 18. Also, FAX application 123 makes perform image formation of image data of facsimile, which is received by FAX transmission and reception part 18, by image formation part 17. Also, FAX application 123 may memorize image data of received facsimile in the document box of memory part 19.

In addition, standard application 120 may be installed after start to use of image forming apparatus 1. Namely, for example, when a FAX board of a FAX transmission and reception part is attached, a process of installing FAX application 123 may be performed. Also, a user can install original standard application 120 regardless of the configuration of hardware.

Standard application service I/F part 110 provides an interface for using function of standard application 120 from outside of the application executing part.

Standard application service I/F part 110, for example, may be provided as a class of Java, or the like, an interface of Java language, a routine, a function, a header file, an object, a library, or the like. Also, standard application service I/F part 110 may be provided as service on OS 230, or the like. Also, standard application service I/F part 110 may provide a different interface for each standard application 120.

Also, standard application service I/F part 110 provides a common interface corresponding to the function of standard application 120 as an interface for using the function of standard application 120 by standard function service 310 of extended application platform 300. The details of this common interface are described later.

In addition, standard application service I/F part 110 can also perform execution, installation, change setting, deletion, or the like, for standard application 120.

Apparatus control platform 200 includes platform service I/F part 210 (platform service interface part), each part controlling service 220, and OS 230.

Platform service I/F part 210 provides an interface for using hardware resources from the outside of apparatus control platform 200.

Platform service I/F part 210 calls each part controlling service 220 and makes the hardware resources of each part of image forming apparatus 1 use. Platform service I/F part 210 may be provided, for example, as API, service on OS 230, or the like. Also, platform service I/F part 210 may be provided as a structure of C language, a class of C++ language, another types of object data, a routine, a function, a header file, an object file, a library, or the like (henceforth, a “class or the like.”) Also, platform service I/F part 210 may be provided with, for example, a file of an intermediate language, such as Java.

Each part controlling service 220 is a service, or the like, that control each part corresponding to the function of image forming apparatus 1 by a suitable method.

Each part controlling service 220 operates, for example, image processing part 11, operation panel part 16, and network transmitting and receiving part 15, or the like, corresponding to a call from platform service I/F part 210. Also, each part controlling service 220 can call a copy function, a network scanning function, a document box function, or the like.

Also, each part controlling service 220 may be a combination of API or the like, and class or the like, according to product line and may be included in firmware.

Each part controlling service 220 includes image processing function service 221, device operation service 222, and network communication service 223.

Image processing function service 221 provides service about making, conversion, and outputting of data for image processing. Image processing function service 221, for example, makes memorize an image data read a manuscript by manuscript reading part 1 with setting up resolution, a color, or the like, in memory part 19 and makes perform image processing of the image data and document data in memory part 19 to image processing part 11. Also, image processing function service 221 renders, from a file, or the like, an image data for being performed image formation by image formation part 17.

Device operation service 222 provides a service for controlling a device of each part, or the like. Device operation service 222 memorizes, for example, image data acquired from manuscript reading part 12 to memory part 19, renders an image on a browser displayed on the display part of operation panel part 16, transmits the rendered image data to image formation part 17 for performing image formation, and performs facsimile transmission of image data memorized in memory part 19 by FAX transmission and reception part 18.

Also, device operation service 222, when image forming apparatus 1 has an option equipment, can call each function that, for example: a bookbinding, a staple, or the like, in case of having a finisher; user authentication by user authentication part in case of having the respective user authentication part by an IC card or biometrics; and acquisition of a camera image, line of sight detection, or the like, incase of having a camera. Also, device operation service 222 may perform control closer to a configuration of a hardware of apparatus, for example, making drive one of the motors of the conveyance part. Also, device operation service 222 may perform a process of acquiring state of each part, or the like.

Network communication service 223 provides a service about network transmission and reception, or the like. Network communication service 223, for example, by using network transmitting and receiving part 15 (as shown in FIG. 1) transmits and receives a file, or the like, between other image forming apparatuses, servers, and a terminal, or the like by various protocols of TCP/IP or UDP. For example, network communication service 223 can also transmit and receive a scanned image data, a file of a document box, or the like. In addition, Network communication service 223 is also possible to perform transmission and reception for image data of facsimile transmission and reception by FAX transmission and reception part 18, and transmission and reception for a user authentication result in case of having a user authentication part, video image data in case of having a camera, or the like. Also, network communication service 223 can transmit and receive about the state of each part of image forming apparatus 1 and the result of the call of the function for each part.

OS 230 controls each part of image forming apparatus 1. As OS 230, for example, a versatile OS, such as Linux (registered trademark), an embedded OS, real-time OS, or the like, can be used. Also, a kernel, a core, or the like, for OS 230, which is a program, data, or the like, for managing schedule and managing basic hardware, may be included in firmware. Also, OS 230 adds control programs, such as a device driver and a script, separately. This device driver may be made with C language, C++ language, assembler language, or the like, which is a language having considered performance.

Extended application platform 300 includes standard function service 310, extended function service 320, OS installation service 330 (operating system installation service), and extended application management part 340.

Standard function service 310 is service, or the like, for using function of standard application 120 corresponding to standard application service I/F part 110.

Standard function service 310 receives the call that specified each function of each standard application 120 from extended application 400, transmits to standard application service I/F part 110, and executes the respective function of the respective standard application 120.

Extended function service 320 is service, or the like, for using the hardware resources corresponding to platform service I/F part 210.

Extended function service 320 receives the call that specified the function of each part of image forming apparatus 1 from extended application 400, transmits to platform service I/F part 210, and executes the respective function of the respective part.

Extended application management part 340 manages and executes extended application 400 that can call standard function service 310 and extended function service 320.

Extended application 400 manages installation, activation that changes to an usable state by image forming apparatus 1, execution, end of execution, uninstallation, or the like, for extended application management part 340 by API of extended application platform 300 (Hereinafter, these processes are called management of “life cycle” of extended application 400).

Also, when extended application management part 340 acquires certification information from operation panel part 16 or the like, extended application management part 340 may change to the usable state by performing activation of extended application 400.

OS installation service 330 is service, or the like, for adding a function to OS 230.

OS installation service 330 installs a control program, such as a device driver or a script, to OS 230. In this case, OS installation service 330 may not change the firmware memorized in ROM, flash memory, or the like, but may make an additional change. Thereafter, OS installation service 330 can also modify contents of a configuration file of OS 230. Accordingly, OS installation service 330, for example, may make, change, and erase a file memorized in a directory, such as “var” or may change databases, such as system registry.

In addition, OS installation service 330 is also possible to change or update a part or a whole of firmware.

Extended application 400 is a program and data of application executed on extended application platform 300. Extended application 400 can execute processes that calls standard function service 310 and uses the function of standard application 120, calls extended function service 320 and uses the function of each part of image forming apparatus 1, or calls OS installation service 330 and install the additional function to OS 230. Therefore, extended application 400 realizes to perform various processing, which cannot be used in image forming apparatus 1 itself.

Also, extended application 400 may be configured to include an executable file that is operated on extended application platform 300 and various data having class information, or the like. In this case, the executable file of extended application 400 may be, for example, a binary file of applications, a file of various script languages, a file of the intermediate language in Java application, a “native” executable file, or the like. Extended application 400 may be a file of the script language or a file of the intermediate language, if there is little restriction of resources, such as a process speed and memory-requirements capacity. Also, extended application 400 may be a file of C language, C++ language, assembler language, or the like, which are excellent in performance, if there is restriction of the resource. In addition to this, extended application 400 may include needed data.

Extended application 400 includes practical-use applications, for example, OCR (Optical Character Recognition), a monitoring camera application, watermark generation, bill generation, staff register management, slip management, contract management, card management, PDF generation, book management, or group management. Also, extended application 400 may be an installer application that performs current updates a device driver on OS 230 and a firmware, another management application, or the like.

Also, a plurality of extended applications 400 may be equipped. Also, extended application 400 may be installed from image forming apparatus 1, other terminals, or the like, and may be memorized in memory part 19. Also, extended application 400 may be memorized in an external recording medium. Also, extended application 400 may be selected whether or not executable as corresponded to model peculiar information of image forming apparatus 1. Also, when each extended application 400 is installed and executed, the “activation,” which is associated with the respective image forming apparatus 1 and is changed to the usable state may be needed. In addition, a different extended application 400 may be installed for each model of image forming apparatus 1, respectively.

[The Detailed Configuration of Standard Application Service I/F Part 110]

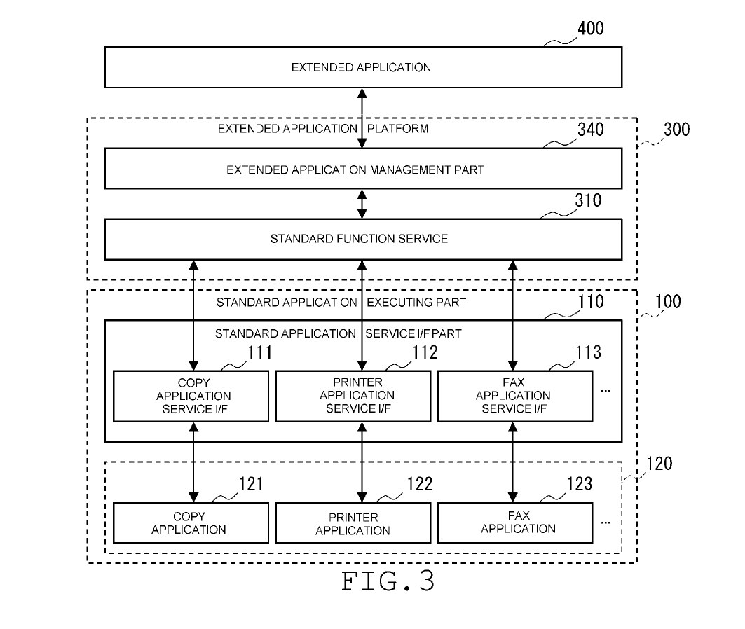

As refer to FIG. 3, a relationship with standard application service I/F part 110, standard function service 310, and each application are explained in detail.

Standard application service I/F part 110 provides a common interface corresponding to the function of standard application 120. Therefore, standard application service I/F part 110 is provided with an interface corresponding to each available function from standard function service 310, respectively.

Also, standard application service I/F part 110 searches presence or absence of standard application 120, and, if the respective standard application 120 is not present, cancels use of standard function service 310 from extended application 400.

When explaining it in detail, standard application service I/F part 110 includes, for example, copy application service I/F 111, printer application service I/F 112, and FAX application service I/F 113, as the common interface corresponding to the function of standard application 120.

Copy application service I/F 111 is an interface corresponding to the function of copy application 121.

Printer application service I/F 112 is an interface corresponding to the function of printer application 122.

FAX application service I/F 113 is an interface corresponding to the function of FAX application 123.

In addition, standard application service I/F part 110 may also include an interface corresponding to various kinds of standard applications 120 other than these interfaces.

Also, when the applications included in standard application 120 is differ in model, a version, or the like, standard application service I/F part 110 may be adapted, respectively. Even in such a case, from standard function service 310, it is accessible to respective standard application 120 with the common interface.

Also, each part, as shown in FIG. 2 and FIG. 3, can be realized by reading the control program memorized in HDD, a flash memory, or the like, to RAM, or the like, in memory part 19, and executing by control part 10.

Also, each part shown in FIG. 2 and FIG. 3, can access and control each part shown in FIG. 1 that is hardware resources, perform reading and writing of various data, transmit and receive, or the like.

[A Standard Application Function Call Process by Image Forming Apparatus 1]

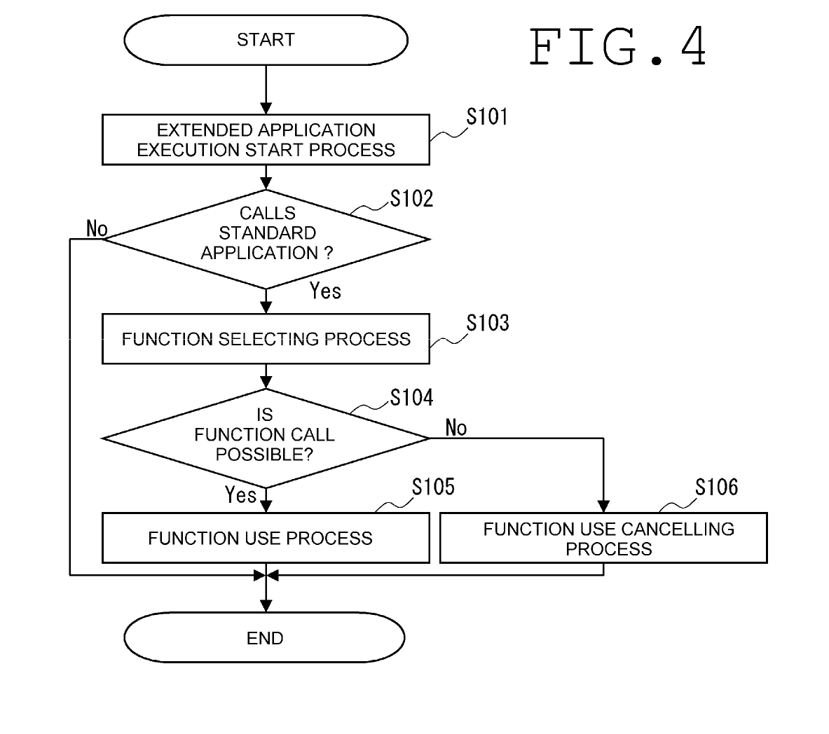

Then, with reference to FIG. 4-FIG. 6, a standard application function call process by image forming apparatus 1 related to the embodiment of the present disclosure is explained.

In the standard application function call process of the present embodiment, when extended application 400 is executed, a process that calls the function of standard application 120 is performed.

In the standard application function call process related to the present embodiment, mainly, control part 10 in image forming apparatus 1 collaborates with each part and executes the program memorized in memory part 19 by using hardware resources.

In the following, with reference to the flow chart of FIG. 4, the details of the standard application function call process are explained for each step.

(Step S101)

At first, extended application management part 340 performs an extended application execution start process.

Extended application management part 340 makes start to execute extended application 400, when extended application 400 is installed from a recording medium, server, terminal, or the like, which is connected, and is accepted an instruction for executing by a user.

In addition, extended application management part 340 may make execute without installing extended application 400.

(Step S102)

Here, standard function service 310 determines whether or not calls standard application 120. If performing a call for extended application 400 to use the function of standard application 120, standard function service 310 determines to Yes. In other cases, standard function service 310 determines to No.

In Yes, standard function service 310 advances a process to Step S103.

In No, standard function service 310 ends the standard application function call process.

(Step S103)

If calling standard application 120, standard function service 310 and standard application service I/F part 110 perform function selecting process for a standard application.

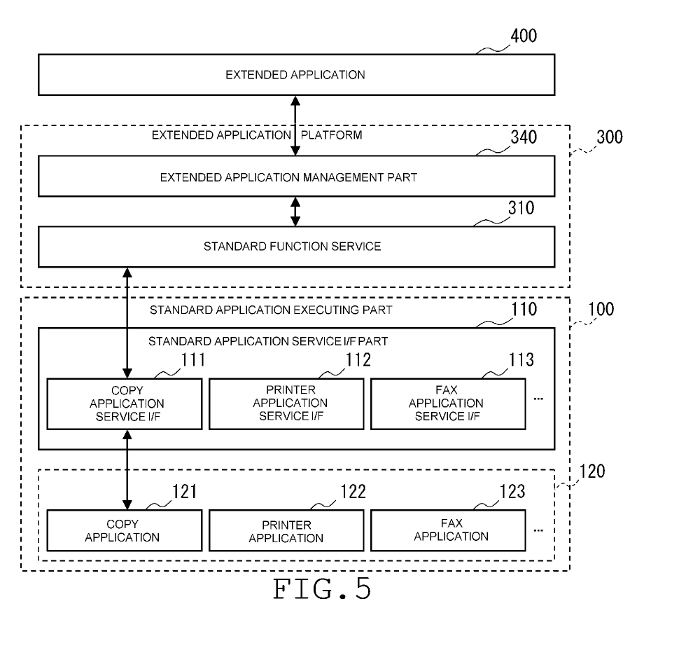

According to FIG. 5, standard function service 310, when there is a call of standard function service 310 from extended application 400 via extended application management part 340, notifies this call to standard application service I/F part 110.

Standard application service I/F part 110 selects the function of standard application 120 corresponding to the function called from standard function service 310 of extended application platform 300.

Standard function service 310 searches whether or not standard application 120 corresponding to the selected function is present and is available in the function. Standard function service 310, for example, by using the response of access to standard application 120 by the common interface of standard application service I/F part 110, or the like, presence or absence of the existence of standard application 120, use availability of a function, or the like, may be searched.

(Step S104)

Then, standard application service I/F part 110 determines whether or not the selected function can be called. If standard application 120 is present as a result of search and is available in the function, standard application service I/F part 110 determines to Yes. If the other case, namely, a case of not existing the corresponding standard application 120, standard application service I/F part 110 determines to No. Also, standard application service I/F part 110, even when standard application 120 corresponding to the called function is present, also if a function cannot be used because of a state of corresponding each part, such as memory capacity of memory part 19 being decreased, may be determines to No.

In Yes, standard application service I/F part 110 advances a process at Step S105.

In No, standard application service I/F part 110 advances a process at Step S106.

(Step S105)

If the selected function can be called, standard application service I/F part 110 performs a function use process.

Standard application service I/F part 110 calls the function of corresponding standard application 120 with the interface corresponding to the selected function.

According to FIG. 5, for example, when calling copy application 121, standard application service I/F part 110 calls the function of copy application 121 by copy application service I/F 111. In this case, for example, standard application service I/F part 110 may display a start screen of a copy on operation panel part 16. Also, standard application service I/F part 110 may call apart of application and may make a respective function use, such as displaying properties, which are resolution and color for a copy, or the like.

Also, for example, when calling printer application 122, standard application service I/F part 110 calls the function of printer application 122 by printer application service I/F 112. In this case, standard application service I/F part 110, for example, various job data, a file, or the like, which extended application 400 acquires or specifies, may be output, or the like, to a recording paper by image formation part 17.

Also, for example, when calling FAX application 123, standard application service I/F part 110 calls the function of FAX application 123 by FAX application service I/F 113. In this case, standard application service I/F part 110, for example, specifies the image data of the facsimile received by FAX transmission and reception part 18 and makes to acquire by extended application 400. Also, standard application service I/F part 110 may make the file, or the like, which is specified by extended application 400, transmit from FAX transmission and reception part 18.

After calling these functions, standard application service I/F part 110 ends a standard application function call process.

In addition, standard application service I/F part 110 can also perform a process that installs, erases, or changes settings for standard application 120 from extended application 400.

(Step S106)

If the call of the selected function is impossible, standard function service 310 performs a function use cancelling process.

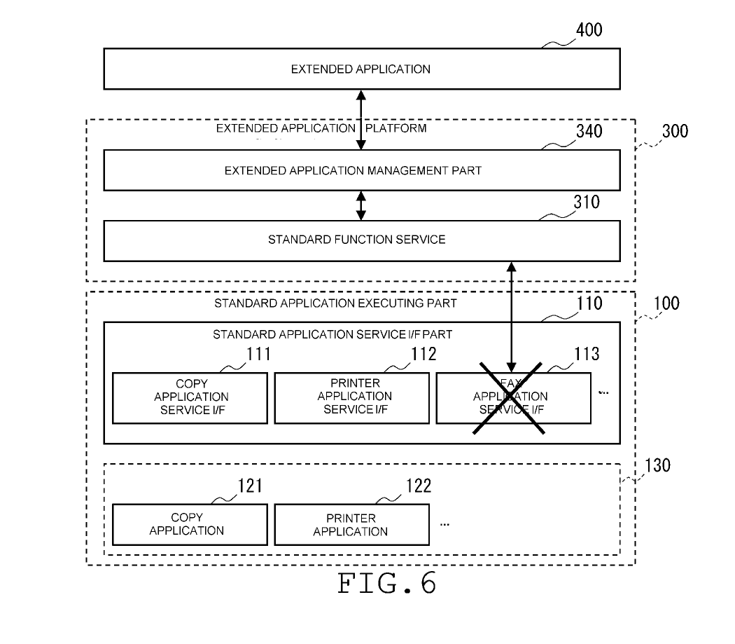

FIG. 6 shows an example of standard application 130 in the state where FAX application 123 corresponding to the function of facsimile transmission and reception is uninstalled because of removing FAX transmission and reception part 18, or the like. In such a case, standard function service 310 is set up, for example, to prohibit the call for the function of the facsimile transmission and reception by FAX application service I/F 113. Thereby, use of the function of facsimile transmission and reception is cancelled after that.

In addition, as the same manner to the example in FIG. 6, even in a single function printer that FAX transmission and reception part 18 is not present initially, FAX application service I/F 113 may be set to standard application service I/F part 110 as the common interface.

As the above-mentioned, the standard application function call process related to the present embodiment is ended.

The following effects can be obtained by configuring as mentioned above.

In a typical platform, when function for providing to a user is extended, there is a problem that the existing application, or the like, is changed, or a new application is to be developed by using function that the platform provides. In order to change the existing application, full knowledge of the existing application, or the like is required.

In addition, if the existing application is changed, the standard function service formed in the relationship between other applications is also affected. Therefore, the influence on the entire platform for extending is difficult to grasp, clearly, and the quality maintenance of the application is difficult. Actually, in order to maintain the quality of an application, evaluation not only the extended function but the existing function is needed, and thus man hour is increased.

On the other hand, if a new application is developed, new control management, which is equivalent to the control management for using the function provided in a platform, must build additionally to the existing application. Namely, in addition to have full knowledge of the complicated control management inside a standard application in standard function service, it needs to develop a program that realizes control management, which is equivalent to the standard application. Therefore, development difficulty is high and requires many man hours.

As a result, when a function is extended on the existing platform, great development cost must be needed.

In contrast to the case, image forming apparatus 1 of the present embodiment is characterized to include: apparatus control platform 200 that manages hardware resources on OS 230; standard application executing part 100 that executes standard application 120 by using hardware resources managed on the apparatus control platform; extended application platform 300 that includes a standard function service for using function of standard application 120 executed by standard application executing part 100; and standard application service I/F part 110 that provides a common interface corresponding to function of standard application 120 as an interface for using function of standard application 120 by standard function service 310 of extended application platform 300.

As configured in this way, the function of standard application 120 can open to extended application platform 300 with the common interface, the function of standard application 120 can be used from extended application platform 300 by using the interface. Thus, because of using the function of standard application 120 from standard application service I/F part 110, the function of standard application 120 can be used, easily.

Also, for image forming apparatus 1 of the present embodiment, even without knowing the inside control management of standard application 120, extended application 400 can be developed. Also, function is extensible without changing standard application 120, and thus influence on standard application executing part 100 or apparatus control platform 200 can be reduced. Accordingly, it leads to the maintenance and improvement in the quality of a whole image forming apparatus 1 and the quality of standard application 120. Also, when a function is extended, an area of influence becomes clear, evaluation is required only in the extended function, and thus evaluation time can be shortened.

Also, image forming apparatus 1 of the present embodiment uses the function of each standard application 120 from extended application platform 300 with a common interface of each standard application service I/F part 110. Therefore, a user who develops extended application 400 becomes unnecessary to have full knowledge of the complicated control management inside standard application 120. Also, it becomes unnecessary to separately-make a similar program to the control management of standard application 120, specially, and to include in extended application 400. In addition, it is enabled to develop as corresponded to the open function with the common interface or the function needed to be extended. Therefore, development of extended application 400 becomes easy, and development processes can be reduced as compared with the typical case.

Namely, it becomes possible to make development of the extended function, easily, to raise development efficiency, and to shorten a development cycle, and thus it can reduce development cost.

Also, image forming apparatus 1 of the present embodiment, in standard function service 310 of extended application platform 300, uses each standard application 120 with the common interface, and thus difference inside standard application 120 is not recognized from the side of extended application 400.

Therefore, it becomes usable the same standard application executing part 100 and extended application platform 300 even in a different model. As a result, the same extended application 400 can be used in the different model.

Also, image forming apparatus 1 of the present embodiment, by using extended application platform 300, which is hierarchical, becomes respectively usable the hardware resources corresponding to the function or each part of standard application 120 from extended application 400. Therefore, it can provide the image forming apparatus that becomes easy to customize, which is changing a configuration according to a customer, and reduces development cost.

That is, if it is just necessary to use the function of standard application 120, image forming apparatus 1 of the present embodiment can be quickly developed by a script language, or the like. On the contrary, if it is necessary to customize, which controls hardware resources directly, it can be called the function of each part without passing through standard application 120. Thus, image forming apparatus 1 of the present embodiment corresponds to request by various customers, and the difference in the needed level of customization is absorbed on extended application platform 300 which is hierarchical. Thereby, it can support easily to the difference in the level of needed customization. Also, by extending hierarchization service, the correspondence range of customization can be clarified, and it is possible to make development of extended application 400 easy. Also, it becomes unnecessary to prepare SDK (Software Development Kit), NDK (Native Development Kit), or the like, which is different in level, especially.

Also, since image forming apparatus 1 of the present embodiment has a software architecture, which the platform is made hierarchy, image forming apparatus 1 corresponding to a product adapted to new service, which a customer desires, can be provided with being shortened a development cycle. Namely, the new technology that a customer requires is reflected promptly, and it becomes possible to provide a product of an image forming apparatus having optimum performance and function with a low price, quickly.

Also, image forming apparatus 1 in the present embodiment becomes easy to provide the interface of a form unified on standard application 120 and apparatus control platform 200, becomes easy to make extended application 400 in unified development environment, and can reduce development cost.

Also, the function of standard application 120 and the hardware resources used by apparatus control platform 200 can be executed from extended application 400, separately. Therefore, performance, such as speed of the run time of extended application 400, can be raised.

Also, in a typical case, when a new application is developed by using the function that a platform provides or is changed the existing application, or the like, to extend the function, the control management for calling a function is changed by presence or absence of each application in the environment for each apparatus and is needed to test. Therefore, development processes is increased, and development cost is raised. Also, only for an extension of a part of functions, the entire firmware of apparatus is need to be updated in order to unify the environment of the existing application.

As compared with this, as for image forming apparatus 1 related to the present embodiment, standard function service 310 searches presence or absence of standard application 120, and if standard application 120 is not present, use of standard function service 310 from extended application 400 is cancelled.

As configured in this way, in extended application 400, changing and testing control management as corresponded to the presence or absence of standard application 120 in the respective image forming apparatus 1 becomes unnecessary. Therefore, development cost can be reduced. Also, it becomes unnecessary to update the entire firmware each time to add a function, and usability for a user is raised.

### Other Embodiments

In addition, as an interface common to standard application service I/F part 110 in an above-mentioned embodiment, it is explained that copy application service I/F 111, printer application service I/F 112, and FAX application service I/F 113, or the like, are included.

However, it may be configured so that a common interface is included in the side of standard function service 310 other than in the side of standard application service I/F part 110.

Thereby, as standard application service I/F part 110, the respective interface is prepared for each model, and it enables a configuration that absorbs the difference by standard function service 310. That is, even if the interfaces of standard application service I/F part 110 differ for each model, by standard function service 310 corresponding to the difference, it becomes possible to make the different interfaces adapt.

Also, in the above-mentioned embodiment, it is described that extended application 400 uses each standard application 120 with a common interface by standard function service 310 of extended application platform 300.

However, it may be a configuration that extended application 400 can access each standard application 120 by an interface of provided in each standard application 120 and can use function, directly. In this case, it may also be usable in the function of each standard application 120 in a different model from the same extended application 400.

As configured in this way, it can be control standard application 120, flexibly, and it becomes easy to make a extended application 400 by using a unique function of standard application 120. Also, it enables to make extended application 400 depend on the difference in version for standard application 120, or the like.

Also, the above-mentioned embodiment explains an example to call standard application 120, or the like, from extended application 400. However, extended application 400 may be called respectively from standard application 120, each part controlling service 220, OS 230, or the like. Also, function may be called between standard applications 120s by standard application service I/F part 110.

Also, extended application 400 may include a “general application” for calling each function of image forming apparatus 1 and realizing a desired function and a “management application” for managing these general applications.

As configured in this way, it becomes possible to control image forming apparatus 1 by extended application 400, flexibly, and can enhance security.

Also, in the above-mentioned embodiment, it is described that standard application 120 and extended application 400 are in a state already memorized in memory part 19.

However, it is also possible to install and memorize standard application 120 and extended application 400 in memory part 19 from an external recording medium connected to image forming apparatus 1, a recording medium connected to an external server, and an external terminal connected via the network, or the like. In this case, the respective standard application 120 and extended application 400 may be set up for being usable only from the installed user, image forming apparatus 1, or the terminal.

As configured in this way, the extension of the function can be realized, flexibly, and management cost can be reduced.

Also, it is possible to memorize a type of application, which is different from a standard application and extended application 400, in memory part 19 of image forming apparatus 1. For example, in memory part 19, web applications other than extended application 400, or the like (henceforth “an external application,”) user data, or the like, may be memorized. An external application may be called by an instruction by the user in operation panel part 16 in image forming apparatus 1 and may be read and executed in image forming apparatus 1.

As configured in this way, each of an application of extended application platform 300 and an external application are used flexibly, and usability of a user can be raised.

Also, the present disclosure is applicable to variety of information processing apparatus other than an image forming apparatus. That is, it may be configured, such as a network scanner, a server connecting a scanner by USB, separately, or the like, are used. Also, it is applicable to PC, a smart phone, a mobile phone, office equipment, industrial equipment, etc. which are information processing equipment being able to install an application.

The configuration and operation of the above-mentioned embodiment are an example, and it cannot be overemphasized that it can change suitably and can execute in the range that does not deviate from the aim of the present disclosure.

What is claimed is:

1. An image forming comprising:
a control circuit, the control circuit including
an apparatus control platform that manages hardware resources on an operating system,
a standard-application executing part that executes a standard application by using hardware resources managed on the apparatus control platform,
an extended application platform that includes a standard function service for using function of the standard application executed by the standard-application executing part, and
a standard application service interface part that provides a common interface corresponding to the function of the standard application as an interface for using the function of the standard application by the standard function service of the extended application platform.

2. The image forming apparatus according to claim 1, wherein
the standard function service searches presence or absence of the standard application, and
when the standard application does not present, cancels use of the standard function service from the extended application.

3. An image formation method executed by an image forming apparatus having hardware resources, comprising:
managing hardware resources on an operating system;
executing a standard application by using managed hardware resources;
using function of executed standard application;
using the hardware resources; and
providing a common interface corresponding to the function of the standard application as an interface for using the function of the standard application.

4. A computer readable non-transitory recording medium storing a control program executable by the image forming apparatus, the control program causing the image forming apparatus to:
manage hardware resources on an operating system;
execute the standard application by using managed hardware resources;
use function of executed standard application;
use the hardware resources; and
provide a common interface corresponding to the function of the standard application as an interface for using the function of the standard application.
